(19) United States
(12) Patent Application Publication
(10) Pub. No.: US 2021/0382177 A1
(43) Pub. Date: Dec. 9, 2021

(54) SYSTEM FOR MONITORING SURROUNDINGS OF VEHICLE

(71) Applicant: DENSO CORPORATION, Kariya-city (JP)

(72) Inventors: Toshiaki NAGAI, Kariya-city (JP); Teiyu KIMURA, Kariya-city (JP); Fumiaki MIZUNO, Kariya-city (JP); Akifumi UENO, Kariya-city (JP)

(21) Appl. No.: 17/406,588

(22) Filed: Aug. 19, 2021

Related U.S. Application Data
(63) Continuation of application No. PCT/JP2020/002130, filed on Jan. 22, 2020.

(30) Foreign Application Priority Data
Feb. 20, 2019 (JP) 2019-028027
Jan. 15, 2020 (JP) 2020-004060

(51) Int. Cl. G01S 17/931; G01S 17/08; G06K 9/00

(52) U.S. Cl. CPC G01S 17/931; G06K 9/00805; G01S 17/08

(57) ABSTRACT

In a system for monitoring surroundings of a vehicle, an optical ranging device including a light emitting unit, a light receiving unit configured to receive reflected light from a measurement region, toward which the illumination light from the light emitting unit is projected, and a measurement unit configured to measure a distance to an object within the measurement region using a signal corresponding to a state of the reflected light, output from the light receiving unit. A shape of the measurement region as the illumination light is projected along a horizontal direction onto a cylindrical plane along a vertical direction, surrounding the optical ranging device, is a narrow-at-end shape. The optical ranging device and another optical ranging device are arranged on the vehicle such that the illumination light from the optical ranging device has a larger depression angle than illumination light from the other optical ranging device.

### CROSS-REFERENCE TO RELATED APPLICATION

This application is based on and claims the benefit of priority from earlier Japanese Patent Applications No. 2019-028027 filed Feb. 20, 2019, and No. 2020-004060 filed Jan. 15, 2020, the contents of which are incorporated herein by reference.

### BACKGROUND

### Technical Field

The present disclosure relates to a system for monitoring surroundings of a vehicle.

### Related Art

An optical ranging device is known which measures a distance to an object by illuminating the object with light and measuring its reflected light. For example, a vehicle surroundings monitoring system is known which measures distances to objects around a vehicle in all directions using an optical ranging device mounted to the vehicle.

### BRIEF DESCRIPTION OF THE DRAWINGS

In the accompanying drawings:

FIG. 1 is a schematic diagram of an optical ranging device according to a first embodiment;

FIG. 2 is a schematic diagram of an optical system;

FIG. 3 is a schematic illustration of a light receiving array;

FIG. 4 is a schematic diagram of the SPAD calculation unit;

FIG. 5 is an illustration of movement of a mirror in a vertical and a horizontal illuminating direction;

FIG. 6 is an illustration of movement of the mirror in a synthetic illuminating direction;

FIG. 7 is an illustration of a measurement region of the optical ranging system according to the first embodiment;

FIG. 8 is an illustration of a measurement region, in a vertical direction, of the vehicle surroundings monitoring system according to the first embodiment;

FIG. 9 is an illustration of a measurement region of a second optical ranging device;

FIG. 10 is an illustration of a measurement region, in a horizontal direction, of the vehicle surroundings monitoring system;

FIG. 11 is a schematic diagram of a first optical ranging device according to a second embodiment;

FIG. 12 is a schematic diagram of a light emitting element array;

FIG. 13 is an illustration of control of the mirror and the light emitter array;

FIG. 14 is an illustration of a measurement region of a first optical ranging device according to the second embodiment;

FIG. 15 is a schematic diagram of a first optical ranging device according to a third embodiment; and

FIG. 16 is an illustration of a measurement region of a first optical ranging device according to a fourth embodiment.

### DESCRIPTION OF SPECIFIC EMBODIMENTS

In the above known vehicle surroundings monitoring system, as disclosed in JP-A-2017-125790, a range of illumination light is commonly rectangular in shape to enable the optical ranging device to measure the region that completely surrounds the vehicle. When the illuminating direction of illumination light has a certain depression angle relative to the horizontal direction, the distance to a road surface increases at the horizontal end of the measurement region and thus the coverage of illumination light expands. This may give rise to an issue that regions near the vehicle can not be measured efficiently. In addition, there is an issue that use of a combination of such an optical ranging device as oriented in the horizontal direction and such an optical ranging device as oriented in a direction having a certain depression angle relative to the horizontal direction may lead to increased overlap of the measurement regions of these optical ranging devices in the vehicle surroundings monitoring system, which may reduce the efficiency.

In view of the above, it is desired to have a technique capable of overcoming at least part of the above issue.

One aspect of the present disclosure provides a system for monitoring surroundings of a vehicle. This system is herein also referred to as a vehicle surroundings monitoring system. In this system, a first optical ranging device includes a light emitting unit configured to emit first illumination light, a light receiving unit configured to receive first reflected light from a first measurement region, toward which the first illumination light is projected, and output a signal corresponding to a state of the first reflected light, and a measurement unit configured to measure a distance to an object within the first measurement region using the signal output from the light receiving unit, a shape of the first measurement region as the first illumination light is projected along a horizontal direction onto a cylindrical plane along a vertical direction, surrounding the first optical ranging device, being a narrow-at-end shape defined such that a vertical width at at least one of horizontal ends of the first measurement region is less than a vertical width at a horizontal center of the first measurement region. A second optical ranging device is configured to receive second reflected light from a second measurement region, toward which the second illumination light is projected, and measure a distance to an object within the second measurement region using a signal corresponding to a state of the second reflected light, a shape of the second measurement region as the second illumination light is projected along a horizontal direction onto a cylindrical plane along a vertical direction, surrounding the second optical ranging device, being defined such that a vertical width at each of horizontal ends of the second measurement region is equal to a vertical width at a horizontal center of the second measurement region. The first optical ranging device and the second optical ranging device are arranged on the vehicle such that the first illumination light from the first optical ranging device has a larger depression angle than the second illumination light from the second optical ranging device.

In accordance with the vehicle surroundings monitoring system configured as above, the measurement region of the first optical ranging device has a narrow-at-end shape such that the vertical width of the measurement region at each of horizontal ends is less than the vertical width at the horizontal center. This enables efficient detection of objects in the vicinity of the first optical ranging device. Overlap of the first measurement region of the first optical ranging device and the second measurement region of the second optical ranging device can be reduced, which enables efficient detection of objects in the vicinity of the vehicle.

The present disclosure may also be implemented in various forms other than the vehicle surroundings monitoring system. For example, the present disclosure may be implemented in other various forms, such as a vehicle surroundings monitoring method, an optical ranging method, a vehicle equipped with the vehicle surroundings monitoring system, a vehicle equipped with the optical ranging device, a control method for controlling the vehicle surroundings monitoring system, a control method for controlling the optical ranging device, and the like.

### A. First Embodiment

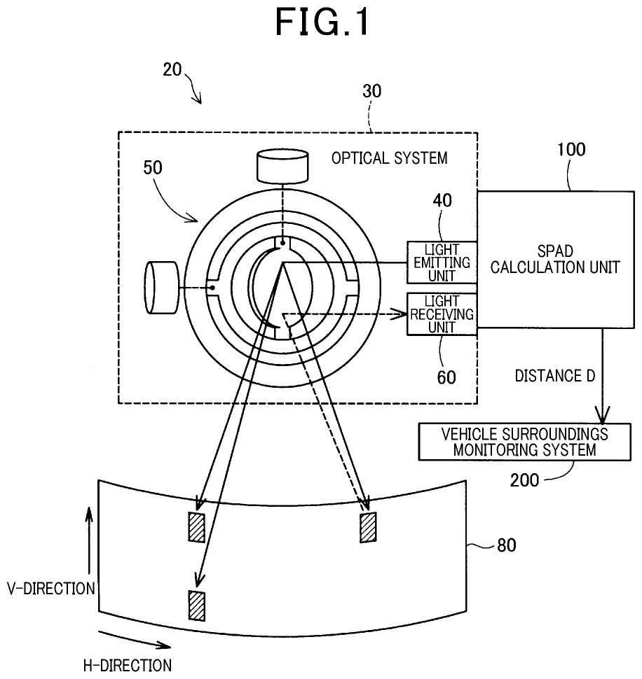

FIG. 1 illustrates an optical ranging device 20 as a first optical ranging device included in a vehicle surroundings monitoring system 200 according to a first embodiment. The optical ranging device 20 is configured to optically measures distances. As illustrated in FIG. 1, the optical ranging device 20 includes an optical system 30 that emits illumination light for ranging over a predetermined measurement region 80 and receives reflected light from an object, and a single photon avalanche diode (SPAD) calculation unit 100 that processes signals acquired from the optical system 30. The optical system 30 includes a light emitting unit 40 that emits a laser beam as illumination light, a projection unit 50 that projects the illumination light toward the measurement region 80, and a light receiving unit 60 that receives the reflected light from the measurement region 80.

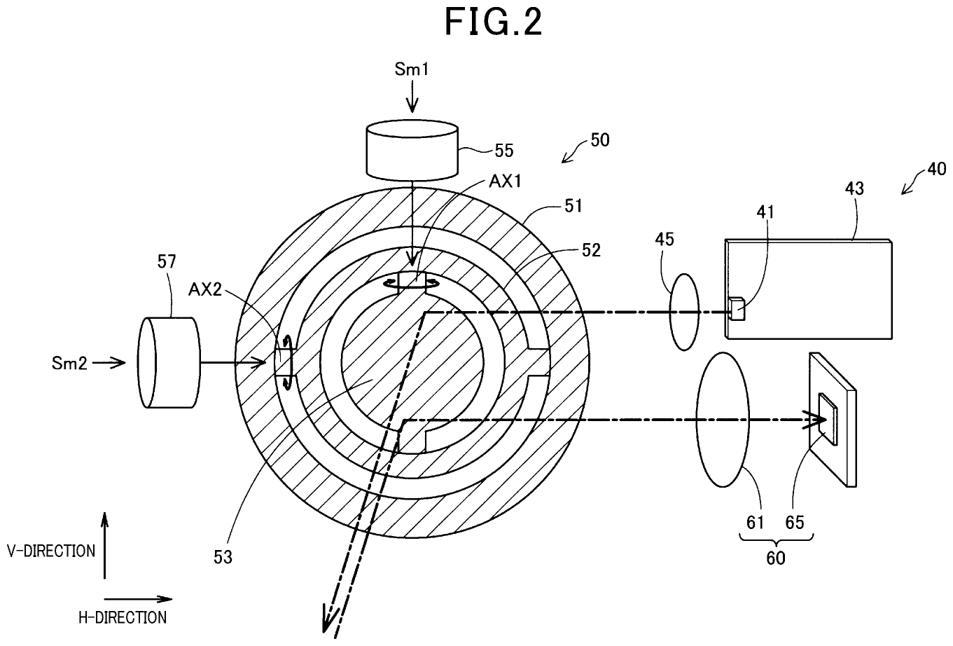

FIG. 2 illustrates details of the optical system 30. In the present embodiment, the light emitting unit 40 includes a semiconductor laser element (hereinafter also referred to simply as a laser element) 41 that emits a ranging laser beam, a circuit board 43 incorporating a drive circuit for the laser element 41, and a collimating lens 45 that makes parallel the laser beam emitted from the laser element 41. The laser element 41 is a laser diode capable of producing a so-called short-pulse laser, and, in the present embodiment, has a vertically elongated light emitting region. The pulse width of the laser beam of the laser element 41 is about 5 nanoseconds (nsec). Use of short pulses of 5 nsec improves the ranging resolution.

The projection unit 50 is, in the present embodiment, a so-called two-dimensional scanner, which vertically and horizontally scans with the illumination light. The projection unit 50 includes a mirror 53 that is a reflector that reflects the laser beam collimated by the collimating lens 45, a rotary frame 52 that supports the mirror 53, a support frame 51 that supports the rotary frame 52, a first rotary solenoid 55 that rotates and drives a first rotary shaft AX1, and a second rotary solenoid 57 that rotates and drives a second rotary shaft AX2. Hereafter, the first rotary solenoid 55 is also referred to simply as a first solenoid 55, and the second rotary solenoid 57 is also referred to simply as a second solenoid 57. The first rotary shaft AX1 is a rotary shaft whose axial direction is a V-direction parallel to the vertical direction, and the second rotary shaft AX2 is a rotary shaft whose axial direction is a H-direction parallel to the horizontal direction.

The first solenoid 55 repeats forward rotation and reverse rotation of the rotation shaft AX1 within a first predetermined rotation angle range upon receipt of an external control signal Sm1. This allows the mirror 53 to rotate relative to the rotating frame 52 within this first predetermined rotation angle range. The second solenoid 57 repeats forward rotation and reverse rotation of the rotary shaft AX2 within a second predetermined rotation angle range upon receipt of an external control signal Sm2. This allows the rotating frame 52 holding the mirror 53 to rotate relative to the support frame 51 within this second predetermined rotation angle range. That is, the mirror 53 of the projection unit 50 is configured to receive the external control signals Sm1 and Sm2 and made rotatable relative to the support frame 51 around the V- and H-directional axes, respectively.

The laser beam incident from the laser element 41 through the collimating lens 45 is reflected by the mirror 53 and illuminated toward the measurement region 80. The measurement region 80 is scanned by rotating the mirror 53 of the projection unit 50 and thereby changing the direction of illumination with the laser beam in the H- and V-directions. The direction of illumination with the laser beam changed by rotating the mirror 53 of the projection unit 50 is hereinafter referred to as an illumination direction. In this manner, the optical system 30 can perform ranging within the measurement region 80 defined by an angular range in the V-direction, i.e., the vertical direction of the laser beam, and an angular range in the H-direction, i.e., the horizontal direction, of the laser beam. The laser beam emitted from the optical ranging device 20 toward the measurement region 80 may be diffusely reflected by a surface of an object, such as a person or a car, and a portion of the laser beam may be returned to the mirror 53 of the projection unit 50. This reflected light is reflected by the mirror 53, enters the light receiving lens 61 of the light receiving unit 60, is collected by the light receiving lens 61, and enters the light receiving array 65.

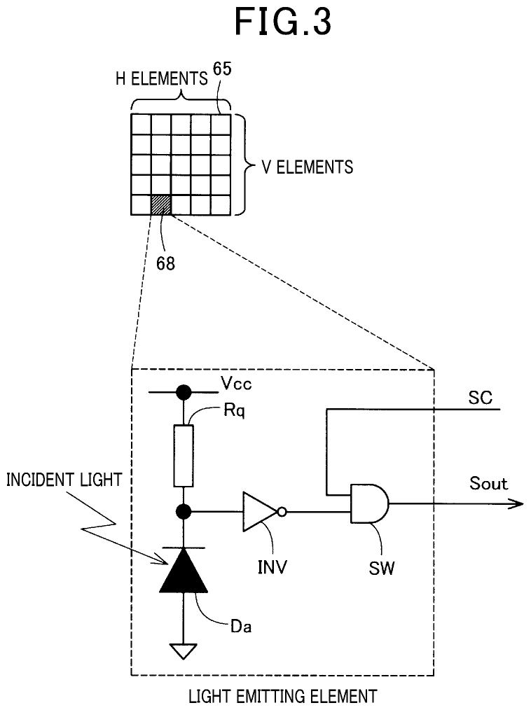

The configuration of the light receiving array 65 is schematically illustrated in FIG. 3. The light receiving array 65 includes a plurality of light receiving elements 68 arranged so as to have H light receiving elements in the horizontal direction and V light receiving elements in the vertical direction. In the present embodiment, the light receiving array 65 may be formed of five receiving elements in each of the horizontal and vertical directions, but may be formed of any number of receiving elements in each of the horizontal and vertical directions. Each light receiving element 68 is an avalanche photodiode (APD) in order to achieve high responsiveness and high detection capability.

When a photon of reflected light is incident on an APD, an electron-hole pair is generated, and the electron and hole are each accelerated by a high electric field, causing collisional ionization one after another to generate new electron-hole pairs (the avalanche phenomenon). Therefore, the APDs can amplify the incident strength of photon. The APDs are often used in cases where the object is far away and the intensity of the reflected light is low. Each APD has two modes of operation: a linear mode, in which the APD is operated at a reverse bias voltage lower than the breakdown voltage, and a Geiger mode, in which the APD is operated at a reverse bias voltage equal to or higher than the breakdown voltage. In the linear mode, the number of electron-hole pairs that exit the high electric field region and annihilate is greater than the number of electron-hole pairs that are generated, and the decay of electron-hole pairs stops spontaneously. Therefore, the output current from the APD is almost proportional to an amount of incident light. In the Geiger mode, the detection sensitivity can be further enhanced as the avalanche phenomenon can occur even when a single photon incident on the APD. The APD operated in such a Geiger mode may also be referred to as a single photon avalanche diode (SPAD).

For each of the light receiving elements 68, as illustrated in the equivalent circuit of FIG. 3, the light receiving element 68 connects a quench resistor Rq and the avalanche diode Da in series between the power supply Vcc and the ground line, and the voltage at the connection point is input to an inverting element INV, which is one of the logical operation elements, and is converted into a digital signal with an inverted voltage level. Since the output of the inverting element INV is connected to one of inputs of the AND circuit SW, it is output to the outside as it is if the other of the inputs is at a high level H. The state of the other of the inputs of the AND circuit SW may be switched by a selection signal SC. The selection signal SC may be referred to as an address signal as it is used to specify from which of the light receiving elements 68 of the light receiving array 65 the signal is to be read out. In the case where the avalanche diode Da is used in the linear mode and its output is handled as an analog signal, an analog switch may be used instead of the AND circuit SW. It is also possible to use a PIN photodiode instead of the avalanche diode Da.

When no light is incident on the light receiving element 68, the avalanche diode Da is kept in a non-conductive state. Therefore, the input side of the inverting element INV is pulled up via the quench resistor Rq, that is, the input side of the inverting element INV is kept at the high level H. The output of the inverting element INV is kept at the low level L. When light is incident on the light receiving element 68 from the outside, the avalanche diode Da is energized by the incident photon. A large current then flows through the quench resistor Rq, the input side of the inverting element INV becomes the low level L once, and the output of the inverting element INV is inverted to the high level H. As a result of the large current flowing through the quench resistor Rq, the voltage applied to the avalanche diode Da decreases, such that power supply to the avalanche diode Da stops and the avalanche diode Da is restored to the non-conductive state. Thus, the output signal of the inverting element INV is also inverted and returns to the low level L. Accordingly, the inverting element INV outputs a pulse signal that is at a high level for a very short time when a photon is incident on the light receiving element 68. Setting the address signal SC to the high level H at the timing the light receiving element 68 receives light will lead to the output signal of the AND circuit SW, that is, the output signal Sout from the light receiving element 68, becoming a digital signal reflecting the state of the avalanche diode Da.

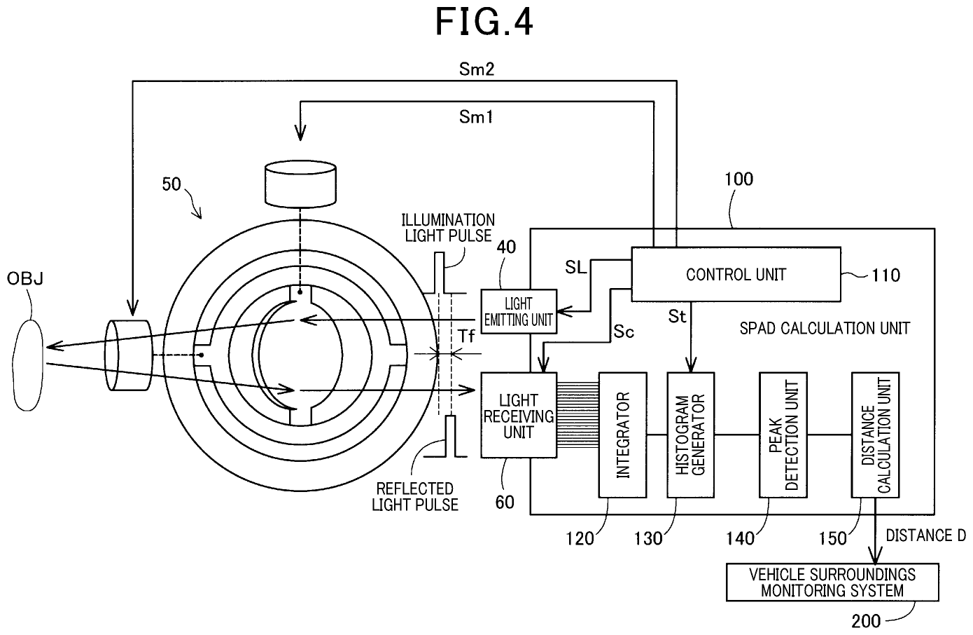

For each of the light receiving elements 68, the output signal Sout of the light receiving element 68 is generated when the laser element 41 emits light and the light is reflected back from the object OM existing in the scanning range. Therefore, as illustrated in FIG. 4, the distance to the object OM can be detected by measuring a time Tf from when the light emitting unit 40 is driven to output a laser beam (hereinafter also referred to as the illumination light pulse) to when the reflected light pulse reflected by the object OM is detected by the light receiving element 68 of the light receiving unit 60. The object OM can exist at any one of various positions from near to far from the optical ranging device 20.

As explained above, the light receiving element 68 outputs the pulse signal upon receipt of the reflected light. The pulse signal output from the light receiving element 68 is input to the SPAD calculation unit 100. The SPAD calculation unit 100 is a measurement unit that calculates a distance to the object OM from a time Tf from when the laser element 41 emits an illumination light pulse to when the light receiving array 65 of the light receiving unit 60 receives a reflected light pulse, while scanning the external space by causing the laser element 41 to emit light. The SPAD calculation unit 100 includes a CPU and a memory, and performs a process necessary for ranging by the CPU executing a program prestored in the memory. Specifically, the SPAD calculation unit 100 includes a controller 110 for overall control, an integrator 120, a histogram generator 130, a peak detector 140, a distance calculator 150, and the like.

The integrator 120 is a circuit for adding outputs from a plurality of light receiving elements included in each of the light receiving elements 68 forming the light receiving unit 60. N×N (N: a positive integer greater than one) light receiving elements are provided within the light receiving element 68. When a reflected light pulse is incident on one light receiving element 68 of the light receiving unit 60, the N×N light receiving elements are activated. In the present embodiment, 7×7 SPADs are provided within one light receiving element 68. Of course, the number and arrangement of SPADs can be configured in various ways other than the 7×7 arrangement, such as a 5×9 arrangement.

In the present embodiment, each light receiving element 68 is formed of a plurality of SPADs due to the characteristics of the SPAD. Although each SPAD can detect a single photon incident thereon, but detection by the SPAD using limited light from the object OM has to be probabilistic. The integrator 120 of the SPAD calculation unit 100 detects the reflected light by summing the output signals Sout from such SPADs that can only detect the reflected light probabilistically. Of course, the light receiving element 68 may be formed of a single SPAD.

The reflected light pulses thus acquired are received by the histogram generator 130. The histogram generator 130 generates a histogram by accumulating the result of summation by the integrator 120 multiple times. Despite the signals detected by the light receiving element 68 including noise due to disturbance light and the like, summing the signals from each of the light receiving elements 68 in response to a plurality of illumination light pulses can make it harder to accumulate the signals corresponding to noise. The signals corresponding to the reflected light pulses are accumulated, which makes clear the signals corresponding to the reflected light pulses. Therefore, the histogram from the histogram generator 130 is analyzed and the peak detection unit 140 detects a signal peak. The signal peak is none other than the reflected light pulse from the object OM that is a target whose distance is to be measured. When the signal peak is thus detected, the distance calculation unit 150 detects a distance D to the object by detecting a time from emission of the illumination light pulse to the peak of the reflected light pulse. The detected distance D is output to the vehicle surroundings monitoring system 200 mounted to the vehicle 70 described below. The distance D may be output to, for example, an autonomous driving device of an autonomous driving vehicle carrying the optical ranging device 20, or may be mounted to various mobile objects, such as a drone, a train, or a ship in addition to the vehicle 70, or may be used alone as a fixed ranging device.

The control unit 110 outputs a command signal SL to the circuit board 43 of the light emitting unit 40 for determining the timing of emission at the laser element 41, an address signal SC to the light receiving unit 60 for determining which light receiving element 68 is to be activated, a signal St to the histogram generator 130 for indicating the timing of generation of a histogram, and control signals Sm1 and Sm2 to the respective solenoids 55 and 57 of the projection unit 50. By the control unit 110 outputting these signals at predetermined timings, the SPAD calculation unit 100 detects the object OM present within the measurement region 80 together with the distance D to the object OBI

The measurement region 80 of the optical ranging device 20 will now be described in detail with reference to FIGS. 5 to 7. As described above, the mirror 53 of the projection unit 50 is configured to be rotatable in the V-direction and the H-direction by receiving the control signals Sm1 and Sm2 from the control unit 110. In FIG. 5, the scanning path for the illumination direction of the mirror 53 is illustrated divided into the V-direction and the H-direction components. The time axes of the respective graphs in FIG. 5 are common to each other.

In FIG. 5, the upper graph shows changes in the V-directional rotation angle over the time axis for the illumination direction of the mirror 53. Given the standard position of the mirror 53 set to zero, the illumination direction of the mirror 53 is set such that the V-directional rotation angle ranges from angle −V1 to angle +V1. This V-directional angular range is the maximum range in the vertical direction that can be measured by the optical ranging device 20 and is also referred to as a vertical optical angle. In FIG. 5, the lower graph shows changes in the H-directional rotation angle over the time axis for the illumination direction of the mirror 53. Given the standard position of the mirror 53 set to zero, the illumination direction of the mirror 53 is set such that the H-directional rotation angle ranges from angle −H1 to angle +H1. This H-directional angular range is the maximum range in the horizontal direction that can be measured by the optical ranging device 20 and is also referred to as a horizontal optical angle.

Given the illumination direction of the mirror 53 set such that the H-directional rotation angle is −H1 and the V-directional rotation angle is zero at time t0, the mirror 53 starts rotating toward the positive angle side in each of the V- and H-directions. In the present embodiment, all angular changes of the mirror 53 are made at a constant rate. When time t1 is reached, the H-directional rotation angle reaches angle +H1 and then decreases toward the negative angle side. When time t2 is reached, the V-directional rotation angle reaches angle +V1 and then decreases toward the negative angle side. When time t3 is reached, the H-directional rotation angle reaches angle −H1 and then again increases toward the positive angle side. The direction of rotation is reversed at each of time t4, time t5, and time t7. Thus, the illumination direction of the mirror 53 is reciprocated three times from angle −H1 to angle +H1 in the H-direction before reaching the time t8. Simple harmonic motion with an amplitude of angle H1 may be repeated three times in the H-direction. When time t6 is reached, the V-directional rotation angle reaches angle −V1 and then increases toward the positive angle side. At time t8, the V-directional rotation angle returns to zero. That is, the illumination direction of the mirror 53 is reciprocated once from angle −V1 to angle +V1 in the V-direction before reaching the time t8. Simple harmonic motion with an amplitude of angle V1 may be repeated once in the V-direction. In this way, the mirror 53 is reciprocated three times in the H-direction while it is reciprocated once in the V-direction. Simple harmonic motion of the mirror 53 may be set such that the frequency in the H-direction of the mirror 53 is three times the frequency in the V-direction.

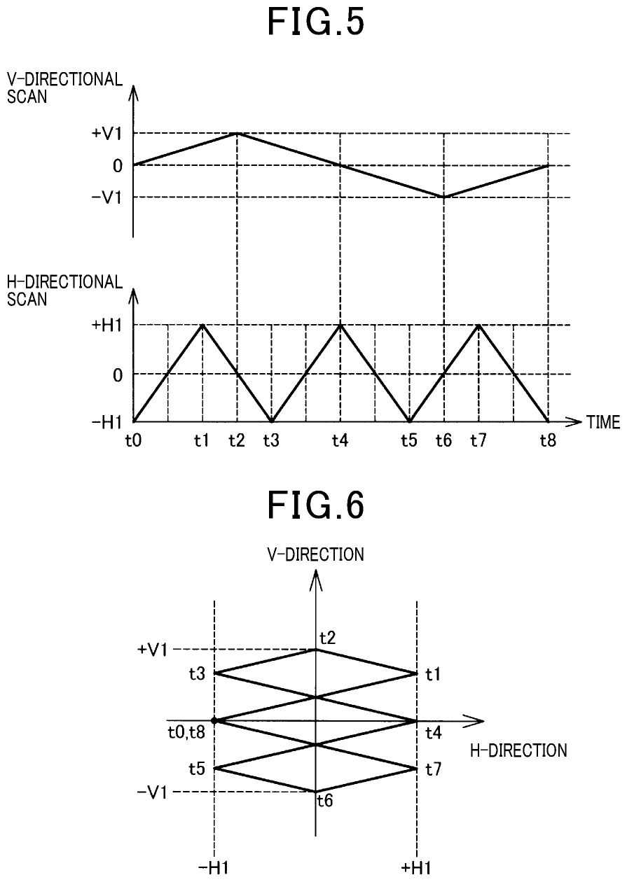

FIG. 6 illustrates the path for the illumination direction of the mirror 53 in the optical ranging device 20. That is, the path for the illumination direction of the mirror 53 acquired by combining angular changes in the H- and V-directions from time t0 to time t8 is illustrated in FIG. 5. In FIG. 6, positions on the path corresponding the respective times t0 to t8 in FIG. 5 are shown to facilitate understanding of the technique of the present disclosure. As described above, the mirror 53 completes three reciprocations from angle −H1 to angle +H1 in the H-direction while completing one reciprocation from angle −V1 to angle +V1 in the V-direction. Thus, as illustrated in FIG. 6, three diamond shapes elongated in the H-direction are arranged in the vertical direction. The path for the illumination direction of the mirror 53 may be a planar figure acquired by combining two oscillations, that is, the V-directional oscillation and the H-directional oscillation, with an amplitude frequency ratio of 1:3. This planar figure is also referred to as a Lissajous figure.

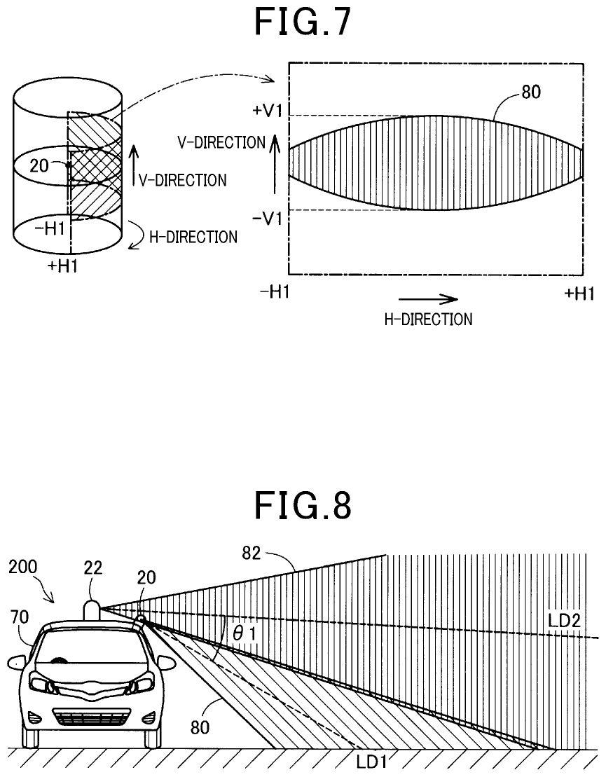

The measurement region 80 of the optical ranging device 20 will now be described in detail. The measurement region 80 is schematically illustrated on the right side of FIG. 7. The measurement region 80 illustrated on the right side of FIG. 7 is projected on a cylindrical screen. The cylindrical screen is a cylindrical plane with the V-direction as the axial direction, as illustrated on the left side of FIG. 7. The measurement region 80 is set up such that the V-directional standard position for the illumination direction of the mirror 53 is parallel to the horizontal direction, and is projected on the cylindrical screen surrounding the mirror 53 at the center. In the present embodiment, the V-directional standard position for the illumination direction of the mirror 53 is the center (zero) of the V-directional angular range.

As illustrated on the right side of FIG. 7, the measurement region 80 is shaped such that the V-directional width of the measurement region 80 at each of the H-directional ends (at angle values of −H1 and +H1 in the present embodiment) is less than the V-directional width at the H-directional center of the measurement region 80. Such a shape is also referred to as a narrow-at-end shape. The narrow-at-end shape also includes a shape in which the V-directional width at at least one H-directional end is less than the V-directional width at the H-directional center of the measurement region 80. The reason why the measurement region 80 has such a narrow-at-end shape is that scanning with the illumination light is performed along the path as illustrated in FIG. 6.

The vehicle surroundings monitoring system 200 of the first embodiment incorporating the optical ranging device 20 will now be described with reference to FIGS. 8 to 10. The vehicle surroundings monitoring system 200 is mounted to a vehicle 70, which is an automobile, and detects objects around the vehicle 70. The vehicle surroundings monitoring system 200 is hereinafter also referred to simply as a monitoring system 200. As illustrated in FIG. 8, the monitoring system 200 includes two optical ranging devices: an optical ranging device 20 disposed on the upper part of the vehicle 70 on the left side of the direction of travel, and an optical ranging device 22 disposed at the center of the upper part of the vehicle 70. The monitoring system 200 detects the presence or absence of an object around the vehicle 70 by receiving an input of a distance D to the object detected by the respective optical ranging devices 20, 22.

The measurement region 82 of the optical ranging device 22 disposed at the center of the upper part of the vehicle 70 is different from the measurement region 80 of the optical ranging device 20, but the optical ranging devices 20, 22 are otherwise similar in configuration to each other. Hereinafter, the optical ranging device 20 is also referred to as a first optical ranging device 20, the optical ranging device 22 is also referred to as a second optical ranging device 22, the measurement region 80 of the first optical ranging device 20 is also referred to as a first measurement region 80, and the measurement region 82 of the second optical ranging device 22 is also referred to as a second measurement region 82. The illumination light projected by the second optical ranging device 22 onto the second measurement region 82 is also referred to as second illumination light, and the reflected light reflected from the second measurement region 82 is also referred to as second reflected light.

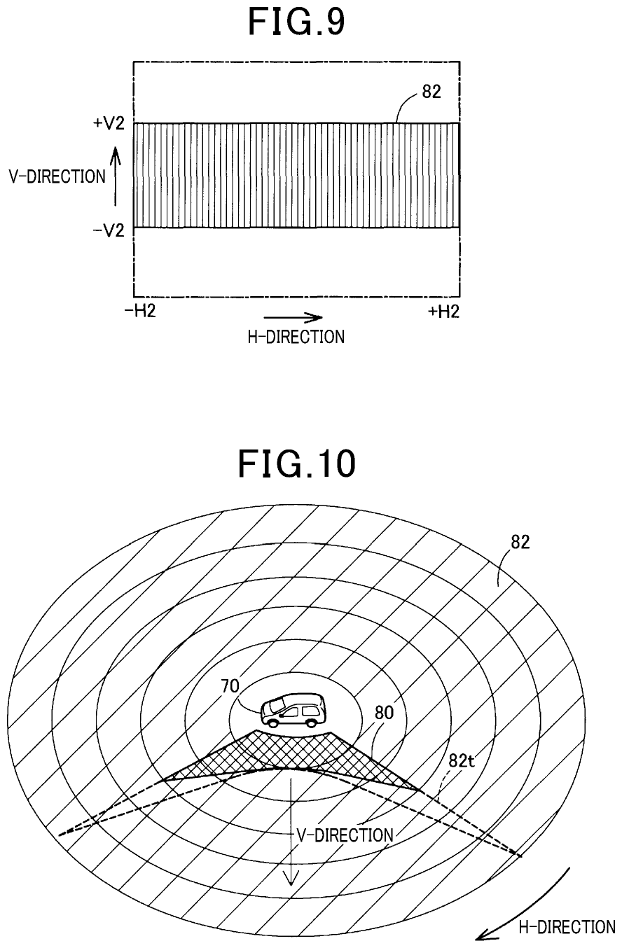

FIG. 9A illustrates an example of projection of the measurement region 82 of the second optical ranging device 22 onto a cylindrical screen. The projection condition for the measurement region 82 of the second optical ranging device 22 is the same as that for the measurement region 80 of the first optical ranging device 20 described above. As illustrated in FIG. 9, the shape of the measurement region 82 of the second optical ranging device 22 is rectangular, such that the V-directional width at the H-directional center of the measurement region 82 and the V-directional width at each of the H-directional ends are substantially equal. The measurement region 82 has such a shape because a rectangular measurement region is scanned with the reflected light by the control unit of the second optical ranging device 22 controlling the mirror. This may be accomplished by scanning in one direction, that is, the H-direction, with the illumination light from a vertically elongated light emitting region.

A detection region of the monitoring system 200 to detect an object will now be described. The detection region of the monitoring system 200 is a combined region of the measurement regions 80, 82 of the respective optical ranging devices 20, 22 forming the monitoring system 200. The detection region of the monitoring system 200 in the vertical direction is illustrated in FIG. 8 by a front view looking along the horizontal direction, and the detection region of the monitoring system 200 in the horizontal direction is illustrated in FIG. 10 by a perspective view centered at the vehicle 70.

As illustrated in FIG. 8, the detection region of the monitoring system 200 is configured such that the measurement region 80 of the first optical ranging device 20 includes a region outside the measurement region 82 of the second optical ranging device 22. FIG. 8 schematically illustrates the illumination direction LD1 of the measurement region 80 of the illumination light from the first optical ranging device 20 and the illumination direction LD2 of the measurement region 82 of the illumination light from the second optical ranging device 22. In the present embodiment, the illumination direction LD2 of the second optical ranging device 22 is set to have a slight depression angle relative to the horizontal direction. In an alternative embodiment, the illumination direction LD2 of the second optical ranging device 22 may be set parallel to the horizontal direction. That is, in this specification, the illumination direction LD2 of the second optical ranging device 22 having a depression angle relative to the horizontal direction may include the horizontal direction. The measurement region 82 of the second optical ranging device 22 is formed in a rectangular shape as illustrated in FIG. 9, so that it extends concentrically on the horizontal plane Hz except in the vicinity of the vehicle 70. In this way, the second optical ranging device 22 is configured to detect objects around the vehicle 70 in all directions except in the vicinity of the vehicle 70, as illustrated in FIG. 10.

The illumination direction LD1 of the measurement region 80 of the first optical ranging device 20 is set to have a depression angle greater than the illumination direction LD2 of the measurement region 82 of the second optical ranging device 22, as illustrated in FIG. 8. That is, the illumination direction LD1 of the first optical ranging device 20 is installed so as to be downwardly directed relative to the illumination direction LD2 of the second optical ranging device 22. In the present embodiment, the angle θ1 between the illumination direction LD1 and the illumination direction LD2 is 20 degrees. In this way, the measurement region 80 of the first optical ranging device 20 covers the region outside and below the measurement region 82 of the second optical ranging device 22.

FIG. 10 illustrates the measurement region 80 of the first optical ranging device 20 as represented on the horizontal plane Hz. The first optical ranging device 20 is installed such that, horizontally, its installation direction is perpendicular to the straight travel direction of the vehicle 70. Here, the region 82t illustrated in FIG. 10 represents the measurement region of the second optical ranging device 22 under assumption that the second optical ranging device 22 is provided instead of the first optical ranging device 20 of the monitoring system 200. The region 82t is formed on the horizontal plane Hz as a region including a region substantially the same as the measurement region 80 of the first optical ranging device 20 and protruding away from the second optical ranging device 22 toward each of the H-directional ends of the measurement region of the second optical ranging device 22. That is, on the horizontal plane Hz, the region 82t is butterfly shaped. The reason why the region 82t protrudes toward each of the H-directional ends on the horizontal plane Hz is that the distance from the second optical ranging device 22 to the horizontal plane Hz increases toward each of the H-directional ends of the measurement region.

As illustrated in FIG. 10, the measurement region 80 of the first optical ranging device 20 has a shorter protrusion toward each of the H-directional ends than the region 82t. Therefore, the overlapping region with the measurement region 82 of the second optical ranging device 22 is smaller than the region 82t. This is because the vertical width of the optical angle at each of the H-directional ends of the measurement region 80 of the first optical ranging device 20 is set less than the vertical width of the optical angle at each of the H-directional ends of the measurement region 82 of the second optical ranging device 22. In other words, this is because the measurement region 80 of the first optical ranging device 20 is set as having a narrow-at-end shape such that the vertical (V-directional) width at each of the H-directional ends of the measurement region 80 is less than the vertical (V-directional) width at the horizontal (H-directional) center of the measurement region 80.

Thus, in accordance with the vehicle surroundings monitoring system 200 of the present embodiment, the first optical ranging device 20 scans the illumination direction of the mirror 53 by separately scanning the H- and V-directions. The measurement region 80 is in a narrow-at-end shape such that the vertical width at each of the horizontal ends is less than the vertical width at the horizontal center. This enables efficient detection of objects in the vicinity of the optical ranging device 20 and in the vicinity of the vehicle 70 carrying the optical ranging device 20. In addition, this can increase the light density of illumination light in the vicinity of the optical ranging device 20 and the vehicle 70 and thus can increase the measurement accuracy.

In accordance with the vehicle surroundings monitoring system 200 of the present embodiment, the overlap of the measurement region 82 of the second optical ranging device 22, extending in all directions of the vehicle 70, and the measurement region 80 of the first optical ranging device 20 can be reduced, which enables efficient detection of objects in the vicinity of the vehicle 70. Increasing the light density of illumination light near the vehicle 70 can increase the measurement accuracy.

In accordance with the vehicle surroundings monitoring system 200 of the present embodiment, the projection unit 50 of the first optical ranging device 20 employs the mirror 53 that is a two-dimensional scanner. This enables separate control of the V-direction and the H-direction in a simple manner. In addition, the first optical ranging device 20 can be downsized by reducing the number of components.

### B. Second Embodiment

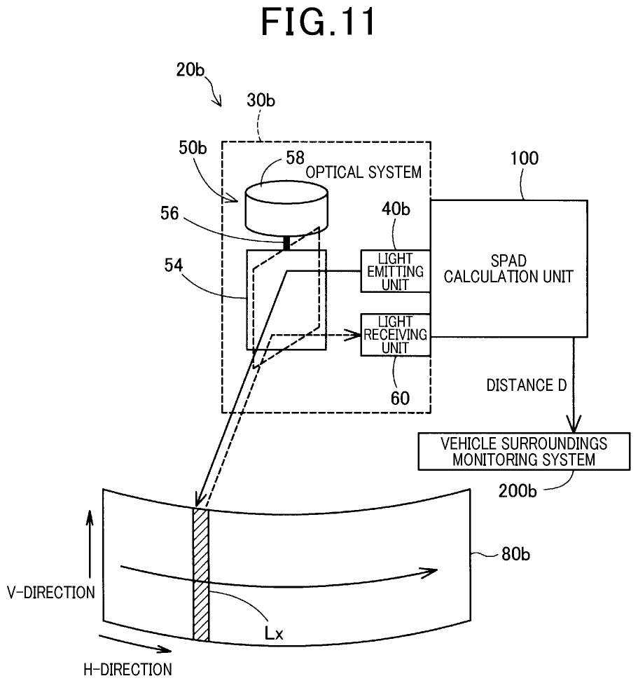

The vehicle surroundings monitoring system 200b according to a second embodiment includes a first optical ranging device 20b in place of the first optical ranging device 20 in the first embodiment. As illustrated in FIG. 11, the optical ranging device 20b includes an optical system 30b in place of the optical system 30 of the optical ranging device 20 in the first embodiment, and the other configuration is the same as that of the optical ranging device 20 in the first embodiment. The optical system 30b includes a light emitting unit 40b and a projection unit 50b.

The projection unit 50b is formed of a so-called one-dimensional scanner. The projection unit 50b includes a mirror 54 that reflects illumination light, a rotary solenoid 58, and a rotation unit 56 that rotates, using the rotary solenoid 58, the mirror 54 in one direction about a rotary shaft having a vertical direction as an axial direction.

The light emitting unit 40b differs from the light emitting unit 40 in the first embodiment in that the light emitting region for emitting the illumination light is different. As illustrated in the lower part of FIG. 11, the illumination region Lx is a vertically elongated rectangular region that includes the entire measurement region in the V-direction. Therefore, in the present embodiment, it is possible to measure the distance over the measurement region 80b at a time simply by providing the projection unit 50b capable of scanning with the illumination light in only one direction.

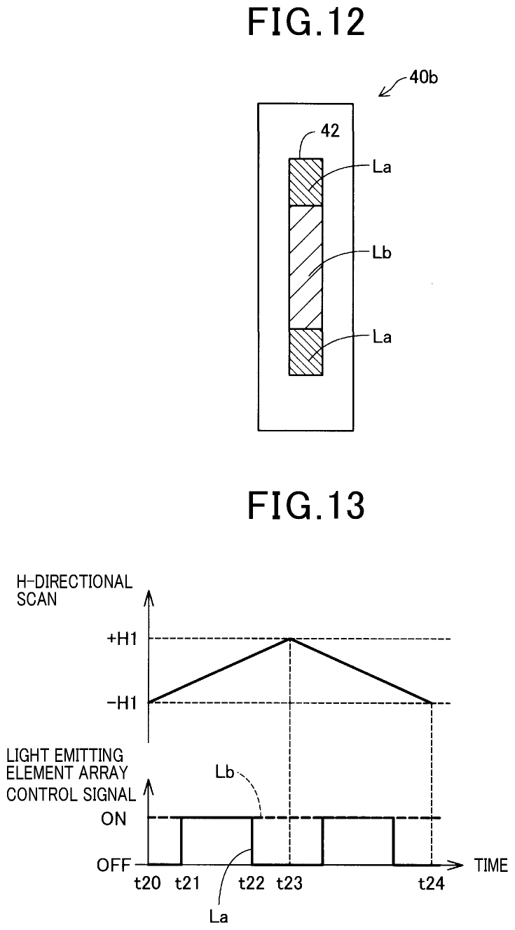

The light emitting unit 40b includes a light emitting element array 42 formed of a plurality of light emitting diodes, as illustrated in FIG. 12. The light emitting element array 42 is divided into the regions La and the region Lb from the point of view of control by the control unit 110. The regions La and Lb of the light emitting element array 42 individually switched on and off under control of the control unit 110. Among the light emitting regions of the light emitting element array 42, the upper and lower regions La are regions respectively corresponding to the upper end side and the lower end side of the illumination region Lx in the V-direction, and the region Lb is a region between the upper and lower regions La and corresponding to the center of the illumination region Lx in the V-direction.

FIG. 13 illustrates an example relationship between control of the scanning direction of the mirror 54 and control of the ON/OFF state of the light emitting element array 42 for each of the light emitting regions La and Lb. The upper side of FIG. 13 illustrates changes over time in the horizontal illumination direction of the mirror 54 of the projection unit 50b, and the lower side of FIG. 13 illustrates control of the ON/OFF state of the light emitting elements for each of the regions La and Lb. The time axes of the upper and lower sides of FIG. 13 coincide with each other. Thus, in the present embodiment, the control of the scanning direction of the projection unit 50b and the ON/OFF state of each of the regions La and Lb of the light emitting element array 42 are controlled in synchronization by the control unit 110.

When the angle of the illumination direction of the mirror 54 at time t20 is −H1, the control unit 110 controls the rotary solenoid 58 to rotate the mirror 54 toward angle +H1 side via the rotating unit 56. At this time, the light emitting element array 42 in the region La is OFF and the light emitting element array 42 in the region Lb is ON. When the mirror 54 initiates rotation and then time t21 is reached, the control unit 110 transmits a control signal to turn on the light emitting element array 42 in the region La. When time t22 is reached, the control unit 110 turns off the light emitting element array 42 in the region La. When the angle of the illumination direction of the mirror 54 reaches angle +H1 (at time t23), the mirror 54 is again rotated toward angle −H1 side, and at time t24, the angle of the illumination direction of the mirror 54 reaches angle −H1. One reciprocation of scanning in the H-direction is then completed. During this period from the time t23 to the time t24, the ON/OFF state of the light emitting element array 42 in each of the regions La is controlled at the same timing as the ON/OFF state of the light emitting element array 42 in each of the regions La is controlled during the period from the time t20 to the time t23. In control of one reciprocation of scanning of the mirror 54, the light emitting element array 42 in the region Lb is always ON. The horizontal scanning of the mirror 54 does not have to be one reciprocation of scanning as long as the detection accuracy is high, and may be controlled only during the period from time t20 to time t23.

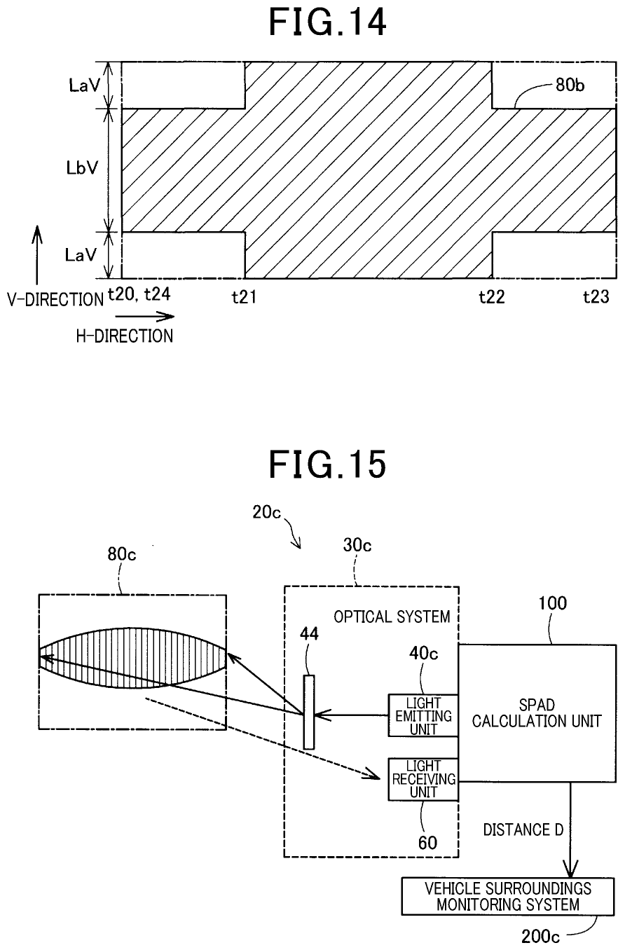

FIG. 14 illustrates the measurement region 80b formed by above-described control of the operation of the mirror 54 and the ON/OFF state of the light emitting element array 42 in each of the regions La and Lb. In FIG. 14, each time t20 to t24 illustrated in FIG. 13 is indicated at the corresponding position to facilitate understanding of the technique of this disclosure. The measurement region 80b illustrated in FIG. 14 is projected onto a cylindrical screen, similar to the measurement region 80 in the first embodiment. The region illuminated by the light emitting element array 42 in the region La is denoted by the region LaV and the region illuminated by the light emitting element array 42 in the region Lb is denoted by the region LbV.

As described above, the light emitting element array 42 belonging to the region La is controlled to be OFF at both ends of the horizontal optical angle range of the mirror 54 corresponding to the times t20 to t21 and t22 to t23. Therefore, in the measurement region 80b, only the region LbV is formed on both sides of the horizontal optical angle range of the mirror 54, and the width in the V-direction is shorter by the upper and lower regions LaV. Thus, the vertical width of the measurement region 80b of the optical ranging device 20b at each of horizontal ends is less than the vertical width at the horizontal center.

As described above, in accordance with the vehicle surroundings monitoring system 200b of the second embodiment, synchronously controlling, in the first optical ranging device 20b, the rotation of the mirror 54 as a one-dimensional scanner and the ON/OFF state of the light emitting element array 42 provides a narrow-at-end shape such that the vertical width of the measurement region 80b at each of the H-horizontal ends is less than the vertical width at the horizontal center. With this configuration, overlap of the measurement region 82 of the second optical ranging device 22 and the measurement region 80b of the first optical ranging device 20b can be reduced while reducing the output of the light emitting unit 40b, which enables efficient detection of objects in the vicinity of the vehicle 70.

### C. Third Embodiment

The configuration of the first optical ranging device 20c of the vehicle surroundings monitoring system 200c according to a third embodiment is illustrated in FIG. 15. The optical ranging device 20c differs from the first optical ranging device 20 in the first embodiment in that it has an optical system 30c in place of the optical system 30. The optical system 30c is configured as a so-called diffuse optical system and includes a light emitting unit 40c formed of the light emitting diode, the light receiving unit 60, and a light diffusing unit 44.

The light diffusing unit 44 is a light diffusing plate including a microlens array. The surface-emitting illumination light emitted from the light emitting diode of the light emitting unit 40c is diffused to a predetermined angle when it passes through the light diffusing unit 44 to form the measurement region 80c. The shape of the measurement region 80c is similar to the shape of the measurement region 80 of the optical ranging device 20 in the first embodiment. The light diffusing unit 44 may be formed of a plurality of lenses arranged side-by-side, or may be formed of any one of various members that diffuse the illumination light from the light emitting unit 40c, such as a flat-top diffuser panel, a diffraction grating, a hologram, and a film diffuser. In accordance with the vehicle surroundings monitoring system 200c of the present embodiment, the first optical ranging device 20c having the measurement region 80c having a narrow-at-end shape, where the vertical width at each of the horizontal ends of the measurement region 80c is less than the vertical width at the horizontal center of the measurement region 80c, can be acquired by a simple method.

### D. Fourth Embodiment

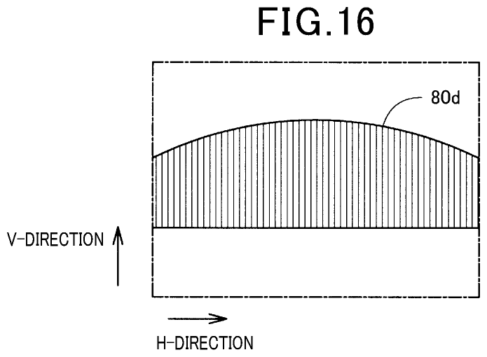

In the first optical ranging device 20 of the vehicle surroundings monitoring system 200 of the first embodiment, the shape of the measurement region 80 was shrunk toward zero from both V-directionally positive and negative sides, at each of the H-directional ends, by making the Lissajous-figure shaped path of illumination direction of the mirror 53. In a fourth embodiment, as illustrated in FIG. 16, the measurement region 80d may be shaped to have a narrow-at-end shape such that the vertical width of the measurement region 80d at each of horizontal ends is less than the vertical width at the horizontal center, by making the V-directional positive side shape curved (more specifically, plano-convex) and the V-directional negative side shape flat. In the first optical ranging device 20b of the vehicle surroundings monitoring system 200b of the second embodiment, the ON/OFF state of the light emitting element array 42 in each of the V-directional upper and lower regions La is controlled in synchronization with rotation control of the mirror 54 as a one-dimensional scanner. In the fourth embodiment, the ON/OFF state of the light emitting element array 42 in only the V-directional upper region La is controlled in synchronization with rotation control of the mirror 54, which leads to the measurement region 80d having the narrow-at-end shape as illustrated in FIG. 16.

### E. Other Embodiments

(E1) In the first embodiment above, the mirror 53 completes three reciprocations from angle −H1 to angle +H1 in the H-direction while completing one reciprocation from angle −V1 to angle +V1 in the V-direction. In an alternative embodiment, the path of illumination direction of the mirror 53 may be set arbitrarily for the oscillation components such as the angular range (amplitude) in each of the V and H-directions, the number of reciprocations (oscillation frequency) in each of the V and H-directions, and the initial phase so that the shape of the measurement region 80 becomes a narrow-at-end shape. The narrow-at-end shape such that the vertical width at each of the horizontal ends of the measurement region 80 is less than the vertical width at the horizontal center of the measurement region 80 can be implemented by a simple method employing a Lissajous figure shaped scanning path of illumination direction of the mirror 53

(E2) In each of the above embodiments, the measurement region is formed as a narrow-at-end shape such that the V-directional width at each of H-directional ends is less than the V-directional width at the H-directional center. In an alternative embodiment, the narrow-at-end shape may be formed as a shape such that the V-directional width at either one of the H-directional ends is less than the V-directional width at the H-directional center. In such a configuration, in cases where the horizontal installation direction of the first optical ranging device 20 installed on the vehicle 70 is set tilted toward the direction of travel or the opposite direction therefrom with respect to the direction perpendicular to the straight traveling direction of the vehicle 70, objects can be detected efficiently by causing the V-directional width corresponding to the H-directional end where overlap with the measurement region 82 of the second optical ranging device 22 is reduced to be less than the V-directional width at the H-directional center.

(E3) In the first embodiment above, the rotation axes of the mirrors 53, that is, vertical and horizontal axes of rotation, are orthogonal to each other. In an alternative embodiment, the rotation axes of the mirrors 53 may not be orthogonal and may intersect at any angle.

(E4) The narrow-at-end shape may be formed by changing the shape of the light emitting unit.

(E5) In each of the above embodiments, the vehicle surroundings monitoring system includes the two optical ranging devices, that is, the first optical ranging device 20 and the second optical ranging device 22. In an alternative embodiment, the vehicle surroundings monitoring system may include three or more optical ranging devices. For example, the vehicle surroundings monitoring system may further include another optical ranging device disposed on the upper part of the vehicle 70 on the right side of the direction of travel.

The present disclosure is not limited to any of the embodiments, examples or modifications described above but may be implemented by a diversity of other configurations without departing from the scope of the disclosure. For example, the technical features of the embodiments, examples or modifications corresponding to the technical features of the respective aspects may be replaced or combined appropriately, in order to solve part or all of the issues described above or in order to achieve part or all of the advantages described above. Any of the technical features may be omitted appropriately unless the technical feature is described as essential herein.

What is claimed is:

1. A system for monitoring surroundings of a vehicle, comprising:
a first optical ranging device including a light emitting unit configured to emit first illumination light, a light receiving unit configured to receive first reflected light from a first measurement region, toward which the first illumination light is projected, and output a signal corresponding to a state of the first reflected light, and a measurement unit configured to measure a distance to an object within the first measurement region using the signal output from the light receiving unit, a shape of the first measurement region as the first illumination light is projected along a horizontal direction onto a cylindrical plane along a vertical direction, surrounding the first optical ranging device, being a narrow-at-end shape defined such that a vertical width at at least one of horizontal ends of the first measurement region is less than a vertical width at a horizontal center of the first measurement region; and
a second optical ranging device configured to receive second reflected light from a second measurement region, toward which the second illumination light is projected, and measure a distance to an object within the second measurement region using a signal corresponding to a state of the second reflected light, a shape of the second measurement region as the second illumination light is projected along a horizontal direction onto a cylindrical plane along a vertical direction, surrounding the second optical ranging device, being defined such that a vertical width at each of horizontal ends of the second measurement region is equal to a vertical width at a horizontal center of the second measurement region,
wherein the first optical ranging device and the second optical ranging device are arranged on the vehicle such that the first illumination light from the first optical ranging device has a larger depression angle than the second illumination light from the second optical ranging device.

2. The system according to claim 1, wherein
the first optical ranging device further includes a projection unit configured to project the first illumination light toward the first measurement region, and
the projection unit includes a reflector configured to rotate about at least two or more central axes and reflect the first illumination light.

3. The system according to claim 2, wherein
the reflector has two mutually orthogonal central axes, and the narrow-at-end shape is implemented by rotating the reflector while changing an oscillation component for each of the two central axes.

4. The system according to claim 2, wherein
the reflector has two mutually orthogonal central axes, and the narrow-at-end shape is implemented by rotating the reflector while changing an oscillation frequency for each of the two central axes.

5. The system according to claim 1, wherein
the first optical ranging device further includes a reflection unit configured to reflect the first illumination light while rotating in one direction, and a projection unit configured to project the first illumination light along the horizontal direction toward the first measurement region, and
the light emitting unit includes a plurality of light emitting elements that are individually switched on and off and are arranged in a direction corresponding to a vertical optical angle of the first measurement region,
the narrow-at-end shape of the first measurement region is implemented by turning off, at at least one of the horizontal ends of the first measurement region, the light emitting elements corresponding to at least a vertical upper end of the vertical optical angle of the first measurement region, and turning on, at the horizontal center of the first measurement region, the light emitting elements corresponding to at least the vertical upper end of the vertical optical angle of the first measurement region.

6. The system according to claim 1, wherein
the first optical ranging device further includes a light diffusing unit configured to diffuse the first illumination light, and the narrow-at-end shape is implemented by the light diffusing unit diffusing more light at the horizontal center of the first measurement region than at at least one of horizontal ends of the first measurement region.
